(19) United States
(12) Patent Application Publication
(10) Pub. No.: US 2006/0257826 A1
(43) Pub. Date: Nov. 16, 2006

(54) System, method, and apparatus for training railroad personnel in rail vehicle safety and maintenance

(75) Inventor: James Edwin Trapp, Riverside, CA (US)

Correspondence Address: BRACEWELL & GIULIANI LLP, P.O. Box 61389, HOUSTON, TX, 77208-1389, US

(73) Assignee: Progress Rail Services Corp.

(21) Appl. No.: 11/126,605

(22) Filed: May 11, 2005

(51) Int. Cl. G09B 9/02; G09B 19/16

(52) U.S. Cl. 434/29

(57) ABSTRACT

A training module is used to train railroad personnel how to detect and correct potential defects on railroad cars. The training module simulates various devices and systems that are commonly found on railroad cars. The training module contains over 100 intentional defects and training items that can be used to properly educate and test personnel for rail vehicle safety and maintenance.

### BACKGROUND OF THE INVENTION

1. Technical Field

The present invention relates in general to railroad safety and, in particular, to an improved system, method, and apparatus for training railroad personnel how to detect and correct potential defects on railroad vehicles.

2. Description of the Related Art

To ensure the safety and maintenance of railroad vehicles or railcars, railroad personnel (e.g., carmen) must be properly trained to inspect equipment for defects or problems to properly recommend repair or replacement of the equipment on the railcars. Typically, training of this nature is done by an experienced carman leading an apprentice from car to car in search of different types of equipment or defects that may be encountered. The Federal Railroad Administration (F.R.A.) requires all employees that perform work on any railcar must be trained and certified by qualified individuals. Examples of certification testing include the single car test, initial terminal air test, 1500 mile or long haul train air test, etc.

When a car is being used as an example for training purposes, the car can be taken out of commission which reduces its value to the owner. Alternatively, an insufficient amount of time to properly train the apprentice may be required to put a car back into use. In addition, rail yards are busy with locomotives, cars, cranes, top-loaders, and trucks and can be potentially hazardous environments. As a result, training carmen can be both time consuming, costly, and inconvenient. Thus, a solution that improves the training of carmen for the ensuring the safety and proper maintenance of railcars would be desirable.

### SUMMARY OF THE INVENTION

One embodiment of a system, method, and apparatus for training railroad personnel how to detect and correct potential defects on railroad cars. A training module simulates various devices and systems that are commonly found on railroad cars. In one version, the training module contains over 100 intentional defects that can be used to properly educate and test personnel for rail vehicle safety and maintenance. The defects are located on a single apparatus which reduces training time. The training module also does not require actual cars or equipment to be taken out of commission. The present invention is used to train personnel to identify all of the defects on the training module in order to prepare them to identify the same types of defects on actual railcars.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a front isometric view of a training module constructed in accordance with the present invention;

FIG. 2 is another isometric view of a training module constructed in accordance with the present invention;

FIG. 3 is another isometric view of a training module constructed in accordance with the present invention;

FIG. 4 is another isometric view of a training module constructed in accordance with the present invention;

FIG. 5 is another isometric view of a training module constructed in accordance with the present invention; and

FIG. 6 is a high level flow diagram of a method constructed in accordance with the present invention.

### DETAILED DESCRIPTION OF THE INVENTION

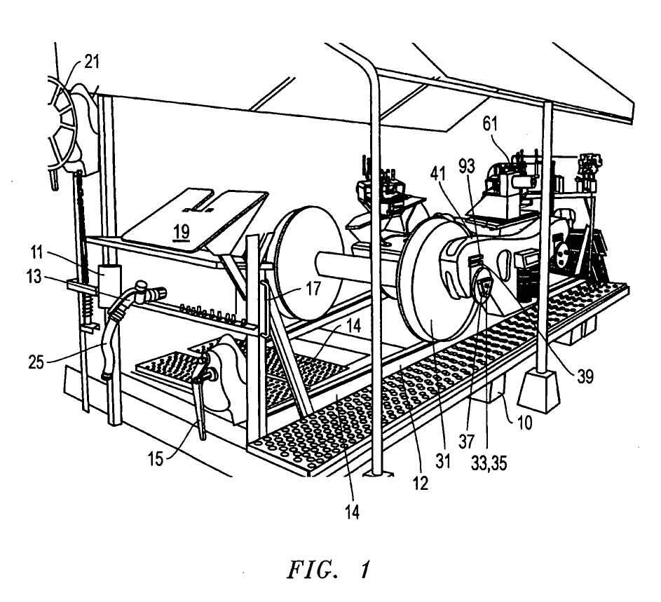

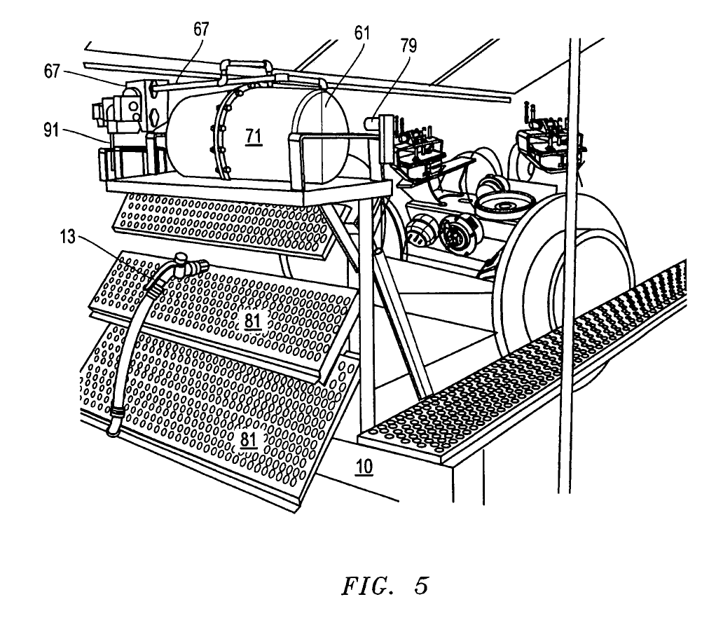

Referring to FIGS. 1-6, a system, method, and apparatus for the safety training of railroad personnel is disclosed. The present invention may be used to educate personnel how to analyze, detect, and correct potential defects or problems that are commonly found on railroad cars. The training module presents and simulates various devices and systems that are utilized on railroad cars and, in one embodiment, contains over 100 intentional defects for such safety training purposes.

The equipment, operation, and inspections presented and simulated by the present invention are more fully described in The Field Manual of the A.A.R. Interchange Rules, Association of American Railroads (A.A.R.), and Railroad Mechanical Department Regulations, including 49 C.F.R. § 215, 218, 231, and 232, as promulgated by the Federal Railroad Administration (F.R.A.), which are incorporated herein by reference.

As shown in FIG. 1, one embodiment of the training module has a foundation 10 comprising a plurality of concrete beams. A pair of rails 12 are mounted and extend across the tops of the beams. Running boards 14 are mounted to the beams between and outside of the rails 12. The following description of equipment on the training module may be mounted directly to the foundation 10 or located on the rails 12. A portable derail device may be located adjacent the training module to simulate protection of a user during an inspection.

The training module includes a coupler 11 that may be used to demonstrate to personnel, such as a carman, how to inspect a car for defective or broken knuckles. The training module has two or more angle cocks 13, worn hand brakes 15, bolt applications 16, safety appliances 17, and a hitch 19 that requires routine lubrication, cleaning, and preparation at regular intervals (e.g., every 18 months). A stencil or other indicator (e.g., visual) may be applied to the equipment or otherwise noted after a defect or set of defects have been identified. For example, a new hitch lube stencil is applied every time service is performed to identify the location of the company performing the work, the date of service to verify the 18 month requirement, and yellow paint on the nipple or pin to indicate the locked or unlocked position, etc.

Another hand brake 21 on the training module simulates the actual operation of a hand brake and where the carman should stand to properly inspect and manipulate the hand brake. The required “tightness” and release pressure for the hand brake are simulated, as are its full release application. After the hand brake is secured, it must have a four-inch clearance and none of the equipment should be fouled or binding. The carman can also verify that chain links and railings on the training module have the required appearance (e.g., painted white).

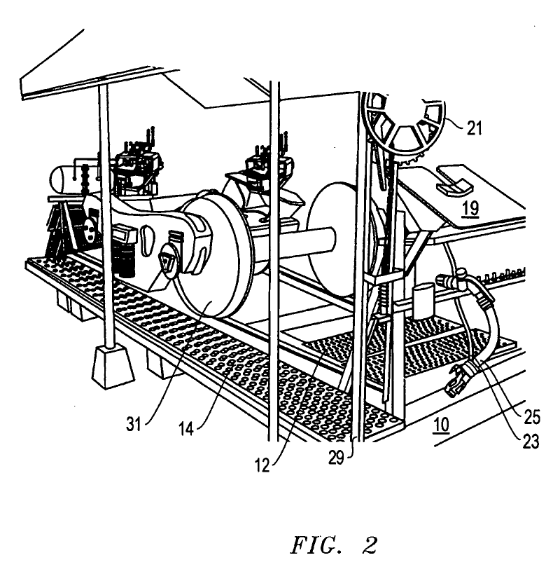

A hose support 23 (FIG. 2) on the training module supports an air hose 25 and requires a five or six-inch clearance that must be inspected by personnel being trained. The training module is also used for instruction regarding placement of a blue flag 27 inside the knuckle for enhancing protection of railcar movers. A complete ladder-style safety appliance 29 is also provided on the training module. The carman can inspect the ladder 29 by attempting to move it to see if anything is loose such as the nuts and bolts that secure it to the training module.

The carman can also inspect and make sure all of the wheels 31 on the training module are properly sized for the vehicle, within the stated requirements, and are not defective. For example, a carman can apply a gauge to a cracked or broken wheel to see if it is condemnable and in need of replacement. The bearings 33 and backing rings 35 also can be identified and inspected for proper size and to make sure that they are not leaking or broken. Cap screws 37 can be inspected to see if they are missing or broken, and that they are secured. In addition, a carman can inspect the adapter and the roof liners 39 to make sure that the adapter is proper, undamaged, and correctly sized for the application.

The training module has a side frame or truck 41 that can be inspected to make sure it is not broken, bent, or involved in a derailment of some kind. The truck 41 should be inspected for springs to make sure nothing is missing or broken. The bolts can be inspected to make sure they are secured and not loose.

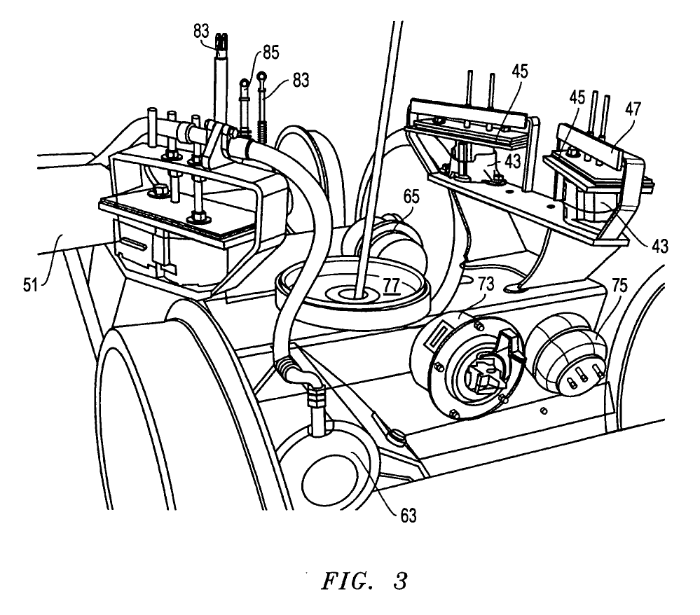

Referring now to FIG. 3, the side bearings 43, shims 45, and side bearing body, case, or housing 47 can be inspected for proper clearance. Threaded bolts are used by the training module to simulate the up-and-down application of the side bearing shims 45. A gauge can be applied to make sure that it is the same on the other side, or at least whatever the car stencil is required. Some car owners specify their own adjustments stenciled on the side of the car. One method is to match both locations of the side bearings 43. A go/no-go gauge and caliper may be used to verify proper measurements before any adjustments are made. If an adjustment is required, a shim 45 can be removed or applied. Once the car is repaired, another measurement can be taken to verify proper clearance or other measurements.

The training module also has a piston travel indicator 51. This equipment allows a carman to get an accurate reading of the piston travel adjustment which is required for inspections for initial terminal. A carman can also inspect the nuts and bolts to make sure that they are properly applied to the car.

The training module also has at least one brake system 61. In one embodiment, four different types of independent brake systems that are commonly utilized in the industry are installed on the training module. Examples include the Ellcon National Brake System 63 and the Thrall-Davis brake or 125-ton brake system 65. Portions of the brake system, including the valves, are painted different colors to indicate the different service and emergency systems. For example, one portion is painted red to indicate emergency application or emergency brake system. Another portion of the brake system is painted green to indicate the service application. A pipe bracket or pipe block 67 and the brake lines may be inspected by the carman for leaks. The training module also has a train line. A stencil on top of the reservoir 71 indicates, for example, “brake pipe length, 81 feet,” the type of service valve, e.g., “D10,” the emergency valve, e.g., “ABDW.” The carman may identify and inspect the equipment for leaking or broken parts, such as broken studs on the reservoir, loose nuts, securement verifications, and brake system applications to make sure that they are all correctly configured.

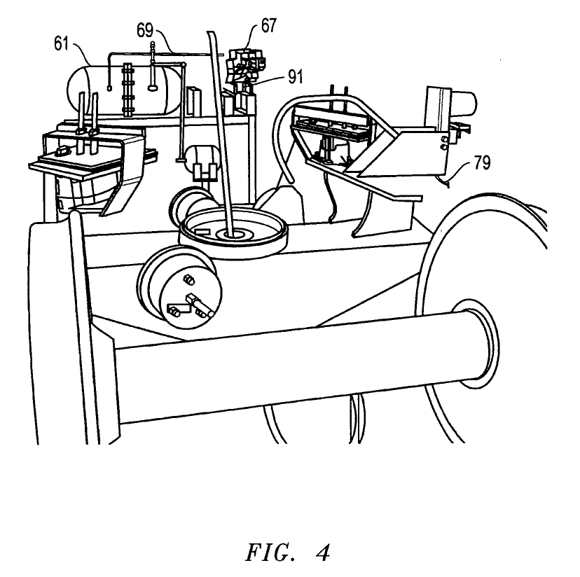

The training module may be equipped with a TMX brake beam mounted cylinder 73 and a truck actuator or “bellow bag” 75. The carman can also look for and inspect the bowl liners 77 for breakage and wear, which may be grounds for removal. The training module also has a tap or brake tap 79 (FIG. 4) for single-car test applications. The training module can operate at any level of desired performance from single-car tests to initial terminal to simply testing the brake systems from trains and different applications.

Personnel also can be trained to adjust the pistons, the slack adjusters, the brake beams to make sure that the pins are present, all of the levers to make sure that they are all present, and the pins to make sure that they have cotter keys and that the cotter keys are properly bent. The training module also has different types of defective running boards 81 for a carman to identify and inspect for cracks and breakage and recommend what needs to be repaired or replaced.

When the carman applies the brake, he can install a “dummy gauge” in the angle cock 13 or train line. The dummy gauge assures him that there is a continuous flow of air and that there is enough charge to set the brakes. Proper instruction also can be given for opening the angle cocks, from safe application to unsafe application including the speed at which to perform this operation. The operation of different types of slack adjustments (e.g., four) may be demonstrated, such as on the universal “C-1000” slack adjuster 83. The cover may be removed so that the carman can identify how it looks inside and how it operates. In one embodiment, a “7100” model 85 may be used to show the carman where the trigger is located and where not to apply his or her fingers to avoid injuries. The need to inspect the nuts and the bolts on cover housings and safety appliances for secure fit and correct application also may be demonstrated.

A small release rod 91 is located on the training module for the carman to understand how the air operates from the retainer valve through the emergencies. The training module may be equipped with an incorrectly sized adapter 93 for the carman to identify. For example, on a 7×12 bearing, a 7×12 adapter is required, rather than a 6½×12 adapter. The load sensors and unitized systems may be tested in both loaded applications and empty applications with the training module.

In one embodiment, the training module includes the following list of approximately 102 or more safety and maintenance items and/or defects (hereinafter, “issues”). For example, the training module may comprise 10 side frame issues, 3 adapter issues (including one broken and wrong size), 4 bolster issues, 2 truck/friction shoe spring issues, 4 brake beam issues, 5 brake shoe/key issues, 2 TMB system issues, 4 TMB cotter/pin issues, 4 stenciling issues, 14 wheel bearing issues, 8 bolt display issues, 5 side bearing issues, 5 brake piping issues, 1 retainer valve issue, 1 release rod issue, 1 cut out cock issue, 3 reservoir issues, 4 control valve issues, 1 auxiliary reservoir issue, 3 angle cock issues, 1 #8 vent valve issue, a hand brake issue (e.g., demonstration), 4 grab iron issues, 6 platform issues, 2 hitch top plate issues, etc.

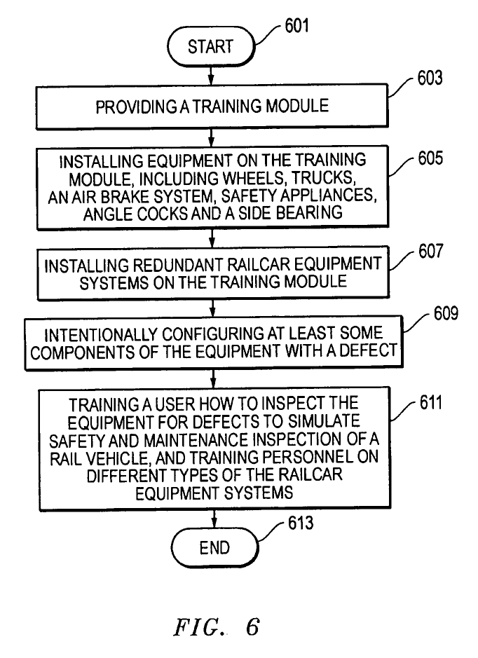

Referring now to FIG. 6, one embodiment of a method of training railroad personnel is disclosed. The method begins as indicated at step 601, and comprises providing a training module (step 603); installing equipment on the training module, including wheels, trucks, an air brake system, safety appliances, angle cocks, and a side bearing (step 605); installing redundant railcar equipment systems on the training module (step 607); intentionally configuring at least some components of the equipment with a defect (step 609); and training a user how to inspect the equipment for defects to simulate safety and maintenance inspection of a rail vehicle, and training personnel on different types of the railcar equipment systems (step 611); before ending as indicated at step 613.

In one embodiment, the method may further comprise providing a foundation having a pair of rails; locating the training module on the pair of rails; and installing a portable derail device to simulate protection of the user during an inspection. In addition, the method may comprise installing a plurality of independent brake systems, a plurality of independent side bearings, and the safety equipment comprises ladders, rails, handholds, and a plurality of different types of running boards. Furthermore, the method may comprise installing the brake system with an air reservoir, at least 75 feet of pipe, pistons, travel adjustment mechanisms, valves, and a plurality of brake beams. Alternatively, the method may further comprise installing a coupler, handbrakes, a hitch, a hose support including a hose, bearings, backing rings, cap screws, adapters, roof liners, a bellow bag, bowl liners, and slack adjustments; and/or performing single-car tests, initial terminal air tests, long haul air test, slack adjuster tests, emergency application tests, leakage tests, and set and released brake applications.

The present invention has several advantages, including the ability to train appropriate railroad personnel how to analyze and inspect railcars and railcar equipment for safety defect detection. The training module relatively small and portable, and is not limited to use in busy rail yards in which personnel would be required to contend with locomotives, cars, cranes, top-loaders, and trucks. Moreover, with almost all potential defects conveniently located on a single apparatus, much less training time is required for both trainers and trainees. The training module also does not require actual cars or equipment to be taken out of commission. Thus, the amount of time required to properly educate and train personnel can be taken without causing delays in usage of actual equipment. Personnel trained to identify all of the defects on the training module are well prepared to identify these types of defects on actual railcars.

While the invention has been shown or described in only some of its forms, it should be apparent to those skilled in the art that it is not so limited, but is susceptible to various changes without departing from the scope of the invention.

What is claimed is:

1. An apparatus for training railroad personnel in rail vehicle safety and maintenance, the apparatus comprising:
a training module having a foundation without a car body, and equipment including wheels, trucks, an air brake system, safety appliances, angle cocks, and a side bearing, each of which has an issue for training a user how to inspect such equipment on a rail vehicle.

2. An apparatus according to claim 1, wherein one of the trucks is in proper working condition and another of the trucks has a defect.

3. An apparatus according to claim 1, wherein the brake system comprises a plurality of independent brake systems.

4. An apparatus according to claim 1, wherein the side bearing comprises a plurality of independent side bearings.

5. An apparatus according to claim 1, wherein the brake system comprises an air reservoir, at least 75 feet of pipe, pistons, piston travel adjustment mechanisms, valves, and a plurality of brake beams.

6. An apparatus according to claim 1, wherein the safety equipment comprises ladders, rails, handholds, and a plurality of different types of running boards.

7. An apparatus according to claim 1, further comprising a coupler, handbrakes, a hitch, a hose support including a hose, bearings, backing rings, cap screws, adapters, roof liners, a bellow bag, bowl liners, and slack adjustments.

8. An apparatus according to claim 1, wherein the training module performs single-car tests, initial terminal air tests, long haul air test, slack adjuster tests, emergency application tests, leakage tests, and set and released brake applications.

9. An apparatus according to claim 1, wherein the foundation comprises a plurality of concrete beams to which are mounted a pair of rails, running boards mounted to the concrete beams both between and outside of the pair of rails, and wherein portions of the training module are mounted directly to the foundation, and other portions of the training module are located to the pair of rails.

10. A system for training railroad personnel, the system comprising:
a foundation having a pair of rails mounted thereto;
a training module located on the foundation, the module having a chassis without a car body, and equipment including wheels, trucks, an air brake system, safety appliances, angle cocks, and a side bearing, at least some of which have a defect for training personnel how to inspect such equipment on a rail vehicle; and
a plurality of redundant railcar equipment systems for training personnel on different types of the railcar equipment systems.

11. A system according to claim 10, wherein one of the trucks is in proper working condition and another of the trucks has the defect.

12. A system according to claim 10, wherein the brake system comprises a plurality of independent brake systems.

13. A system according to claim 10, wherein the side bearing comprises a plurality of independent side bearings.

14. A system according to claim 10, wherein the brake system comprises an air reservoir, at least 75 feet of pipe, pistons, travel adjustment mechanisms, valves, and a plurality of brake beams.

15. A system according to claim 10, wherein the safety equipment comprises ladders, rails, handholds, and a plurality of different types of running boards.

16. A system according to claim 10, further comprising a coupler, handbrakes, a hitch, a hose support including a hose, bearings, backing rings, cap screws, adapters, roof liners, a bellow bag, bowl liners, and slack adjustments.

17. A system according to claim 10, wherein the training module performs single-car tests, initial terminal air tests, long haul air test, slack adjuster tests, emergency application tests, leakage tests, and set and released brake applications.

18. A system according to claim 10, further comprising a portable derail device to simulate protection of a user during an inspection.

19. A system according to claim 10, wherein the foundation comprises a plurality of concrete beams to which are mounted the pair of rails, running boards mounted to the concrete beams both between and outside of the pair of rails, and wherein portions of the training module are mounted directly to the foundation, and other portions of the training module are located to the pair of rails.

20. A method of training railroad personnel, the method comprising:
(a) providing a training module;
(b) installing equipment on the training module, including wheels, trucks, an air brake system, safety appliances, angle cocks, and a side bearing;
(c) installing redundant railcar equipment systems on the training module;
(d) intentionally configuring at least some components of the equipment with a defect; and then
(e) training a user how to inspect the equipment for defects to simulate safety and maintenance inspection of a rail vehicle, and training personnel on different types of the railcar equipment systems.

21. A method according to claim 20, further comprising:
providing a foundation having a pair of rails;
locating the training module on the pair of rails; and
installing a portable derail device to simulate protection of the user during an inspection.

22. A method according to claim 21, wherein step (b) comprises installing a plurality of independent brake systems, a plurality of independent side bearings, and the safety equipment comprises ladders, rails, handholds, and a plurality of different types of running boards.

23. A method according to claim 20, wherein step (b) comprises installing the brake system with an air reservoir, at least 75 feet of pipe, pistons, travel adjustment mechanisms, valves, and a plurality of brake beams.

24. A method according to claim 20, wherein step (b) further comprises installing a coupler, handbrakes, a hitch, a hose support including a hose, bearings, backing rings, cap screws, adapters, roof liners, a bellow bag, bowl liners, and slack adjustments.

25. A method according to claim 20, further comprising performing single-car tests, initial terminal air tests, long haul air test, slack adjuster tests, emergency application tests, leakage tests, and set and released brake applications.
